(19) United States
(12) Patent Application Publication
(10) Pub. No.: US 2026/0065185 A1
(43) Pub. Date: Mar. 5, 2026

(54) METHOD AND SYSTEM FOR OPTIMIZING BUDGET ALLOCATION FOR AN APPLICATION

(71) Applicant: HCL Technologies Limited, New Delhi (IN)

(72) Inventors: Nakulbhai Pampaniya, Noida (IN); Karthikeyan Uthirapathy, Chennai (IN); Hareendran M, Chennai (IN); Maheswari V.S, Chennai (IN)

(21) Appl. No.: 19/082,539

(22) Filed: Mar. 18, 2025

(30) Foreign Application Priority Data
Aug. 27, 2024 (IN) 202411064767

(51) Int. Cl. G06Q 10/0631

(52) U.S. Cl. CPC G06Q 10/06313

(57) ABSTRACT

The disclosure relates to a method and system for optimizing budget allocation for an application. The method includes, for a project of one or more projects associated with the application, and for an environment of one or more environments, receiving a parameter score level corresponding to a parameter, based on relevance of the parameter to the environment, wherein the parameter score level corresponds to a range of parameter score values. Further, for the project and for the environment, a mean environment budget value is derived based on the range of parameter score values corresponding to the set of parameters, and determining a project budget value based on summation of the mean environment budget value and an associated environment weightage corresponding to the one or more environments. The method further includes determining an application budget value based on summation of the project budget values.

### TECHNICAL FIELD

This disclosure relates generally to the field of cloud computing, and in particular, to a method and a system for optimizing budget allocation for an application.

### BACKGROUND

In the present technological landscape, cloud computing has become ubiquitous, playing a critical role in driving business value from cloud investments. A fundamental aspect of managing cloud resources effectively involves the process of creating a cloud budget. A cloud budget involves collecting estimated expenses for a specified period and serves as the foundation for various business decisions, including operational strategies, investment planning, and other financial decisions. However, actual spending often exceeds the budget, which can adversely impact the operations and decisions based on these budgets. Therefore, making informed and accurate cloud allocation decisions is crucial for any entity leveraging cloud technologies.

Entities face several significant challenges when allocating a cloud budget. For example, it is challenging to track how effectively different projects utilize cloud resources, and determining the priorities for various projects and resource allocation is often difficult. Further, defending against the inherent unpredictability of cloud resource demand and costs poses a significant challenge. Cloud providers offer complex and often confusing pricing structures, that makes cost estimation and management difficult. Further, ensuring security and compliance across diverse projects with varying requirements is a major concern, and so is lack of sufficient expertise in cloud computing which leads to suboptimal allocation and utilization of resources. Resource planning in the cloud varies widely depending on the specific needs and demands of different projects. A wide range of cloud services, including Infrastructure as a Service (IAAS), Platform as a Service (PAAS), and Software as a Service (SAAS), adds to the complexity of budget allocation. Different projects have varying requirements for infrastructure, performance, and storage, further complicating budget allocation.

Therefore, there is a need for a comprehensive and efficient approach to cloud budget allocation that can address these issues and ensure optimal use of cloud investments.

### SUMMARY

In an embodiment, a method of optimizing budget allocation for an application is disclosed. The method may include, for a project of one or more projects associated with the application, and for an environment of one or more environments, receiving a parameter score level corresponding to a parameter of a set of parameters, based on relevance of the parameter to the environment, wherein the parameter score level corresponds to a range of parameter score values. Further, for a project of one or more projects associated with the application, the method may include, for the environment, deriving a mean environment budget value based on the range of parameter score values corresponding to each of the set of parameters, and determining a project budget value based on a summation of: the mean environment budget value and an associated environment weightage corresponding to each of the one or more environments. The method may further include determining an application budget value based on a summation of project budget value and an associated project weightage corresponding to each of the one or more projects.

In another embodiment, a system for optimizing budget allocation for an application is disclosed. The system includes a processor and a memory communicatively coupled to the processor. The memory stores a plurality of processor-executable instructions, which upon execution by the processor, cause the processor to, for a project of one or more projects associated with the application, and for an environment of one or more environments, receive a parameter score level corresponding to a parameter of a set of parameters, based on relevance of the parameter to the environment, wherein the parameter score level corresponds to a range of parameter score values. Further, for a project of one or more projects associated with the application, the plurality of processor-executable instructions may further cause the processor to, for the environment, derive a mean environment budget value based on the range of parameter score values corresponding to each of the set of parameters, and determine a project budget value based on a summation of: the mean environment budget value and an associated environment weightage corresponding to each of the one or more environments. The plurality of processor-executable instructions may further cause the processor to determine an application budget value based on a summation of project budget values and an associated project weightage corresponding to the one or more projects.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A is a block diagram of an exemplary system for optimizing budget allocation for an application, in accordance with some embodiments of the present disclosure.

FIG. 1B illustrates a process flow diagram of an overall process of optimizing budget allocation for an application, in accordance with some embodiments.

FIG. 2 is a functional block diagram of a budget allocation optimizing device showing one or more modules, in accordance with some embodiments.

FIG. 3 illustrates a block diagram of an example entity and sub-entity relationship, in accordance with some embodiments.

FIG. 4 is a Table-1 for an exemplary environment representing various parameters, the respective possible parameter score levels, and corresponding range of parameter score values, in accordance with an exemplary embodiment.

FIG. 5 is a Table-2 showing parameter score levels and corresponding range of parameter score values for a set of parameters, for ‘production’ environment, in accordance with example embodiments.

FIG. 6 is Table-3 that shows the process of deriving the application budget value, in accordance with example embodiments.

FIG. 7 is a Table-4 that shows application parameters, entity parameter score levels, and corresponding entity parameter score values, in accordance with example embodiments.

FIG. 8 is a Table-8 that shows a process of determining refined budget for the application corresponding to the application parameters, in accordance with some embodiments.

FIG. 9 is a flowchart of a method of optimizing budget allocation for an application, in accordance with some embodiments of the present disclosure.

FIG. 10 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

For cloud budget allocation, the entity building or hosting the application typically investigates cloud billing histories of sub-entity projects, and budget allocation history of the sub-entity projects. However, the cloud budget problem is more subjective. To this end, the present disclosure provides for a multi-dimensional, multi-level, and multi-layer granular approach to deciding cloud budget allocation. The said approach aims to identify key impact of different parameters on different projects through multi-dimensional analysis, fulfil business and solution requirements, further and takes into account dependency of different environments with respective levels of impact.

The techniques of the present disclosure involve a multi-layer parameter analysis, and take into consideration parameter splitting between the entity and sub-entity layers. Further, the multi-dimensional analysis of the projects and parameters and the multi-dimensional dependency analysis makes the process more robust. Furthermore, the multi-level analysis of the dependencies between projects and parameters with varying levels of impact make the process more accurate.

As per the techniques of the present disclosure, a baseline budget is defined for projects with specific conditions. Further, a level of interdependency between the environment and cost parameters is determined by gathering data from subject matter experts (SMEs) of the sub-entity using multi-parameter and multi-level analysis, to derive the budget. The business perspective is taken into account for assigning priorities, and the budget is further refined based on the priorities.

The process of effective budget allocation of the present disclosure is accomplished first at sub-entity layer and then at entity layer. At the sub-entity layer, data is collected via conducting interviews (i.e. discussions) with sub-entity level manufacturers or developers (i.e. enterprises). Further, at the sub-entity layer, the process includes steps of evaluating the number of projects that were utilized by the sub-entity, decision of projects environment, decision parameter for different projects, baseline project cost, level of impact decision, and project's budget demand. At the entity layer, data is collected after conducting interviews with entity owners or decision makers. Further, at the entity level, the process includes steps of deciding on parameters for project prioritization, and project budget decision based on prioritization. The above steps are discussed in detail, in the subsequent sections of this disclosure.

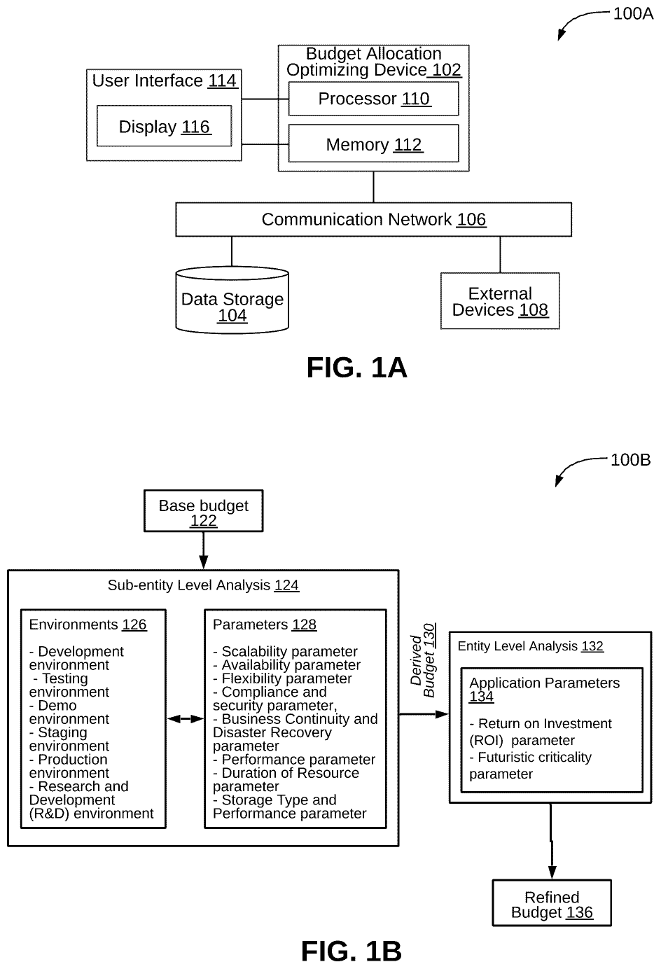

Referring now to FIG. 1A, a block diagram of an exemplary system 100A for optimizing budget allocation for an application, in particular, for a Cloud-hosted application is illustrated, in accordance with some embodiments of the present disclosure. The system 100A may implement a budget allocation optimizing device 102. Further, the system 100A may include a data storage 104. In some embodiments, the data storage 104 may store at least some of the data related to the application. The budget allocation optimizing device 102 may be a computing device having data processing capability. In particular, the budget allocation optimizing device 102 may have the capability for optimizing budget allocation for the application. Examples of the budget allocation optimizing device 102 may include, but are not limited to a desktop, a laptop, a notebook, a netbook, a tablet, a smartphone, a mobile phone, an application server, a web server, or the like.

Additionally, the budget allocation optimizing device 102 may be communicatively coupled to an external device 108 for sending and receiving various data. Examples of the external device 108 may include, but are not limited to, a remote server, digital devices, and a computer system. The budget allocation optimizing device 102 may connect to the external device 108 over a communication network 106. The budget allocation optimizing device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108. For example, the communication network 120 may be a wireless network, a wired network, a cellular network, a Code Division Multiple Access (CDMA) network, a Global System for Mobile Communication (GSM) network, a Long-Term Evolution (LTE) network, a Universal Mobile Telecommunications System (UMTS) network, a Worldwide Interoperability for Microwave Access (WiMAX) network, a Dedicated Short-Range Communications (DSRC) network, a local area network, a wide area network, the Internet, satellite or any other appropriate network required for communication between the budget allocation optimizing device 102 and the data storage 104 and the external device 108.

The budget allocation optimizing device 102 may be configured to perform one or more functionalities that may include, for a project of one or more projects associated with the application, and for an environment of one or more environments, receiving a parameter score level corresponding to a parameter of a set of parameters, based on relevance of the parameter to the environment, wherein the parameter score level corresponds to a range of parameter score values. Further, for a project of one or more projects associated with the application, the one or more functionalities may include, for the environment, deriving a mean environment budget value based on the range of parameter score values corresponding to each of the set of parameters, and determining a project budget value based on a summation of: the mean environment budget value and an associated environment weightage corresponding to each of the one or more environments. The one or more functionalities may further include determining an application budget value based on a summation of project budget value and an associated project weightage corresponding to each of the one or more projects.

To perform the above functionalities, the budget allocation optimizing device 102 may include a processor 110 and a memory 112. The memory 112 may be communicatively coupled to the processor 110. The memory 112 stores a plurality of instructions, which upon execution by the processor 110, cause the processor 110 to perform the above one or more functionalities, The system 100A may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the budget allocation optimizing device 102.

Referring to FIG. 1B, a process flow diagram of an overall process 100B of optimizing budget allocation for an application is illustrated, in accordance with some embodiments. As shown in FIG. 1B, a baseline budget 122 may be defined for the application, at the beginning of the process 100B. A level of interdependency between the environment and parameters may be determined by gathering data from subject matter experts (SMEs) of the sub-entity level analysis and entity level analysis. The baseline budget may not be the most optimized budget, and therefore, by way of the process 100B, a refined budget 136 may be determined.

To this end, at 124, a sub-entity analysis may be carried out for one or more environments 126, based on a set of sub-entity parameters 128 (also referred to as parameters). The one or more environments may include a ‘development’ environment, a ‘testing’ environment, a ‘demo’ environment, a ‘staging’ environment, a ‘production’ environment, and a ‘research and development (R&D)’ environment. The set of parameters may include a ‘scalability’ parameter, an ‘availability’ parameter, a ‘flexibility’ parameter, a ‘compliance and security’ parameter, a ‘business continuity and disaster recovery’ parameter, a ‘performance’ parameter, a ‘duration of resource’ parameter, and a ‘storage type and performance’ parameter.

A derived budget 130 may be calculated based on the one or more environments 126 and the set of sub-entity parameters 128. However, this derived budget may still not represent the most optimum budget, and therefore, the derived budget may further refined. To this end, at 132, an entity level analysis may be performed to refine the derived budget 130, based on application parameters 134 (‘application parameters’ may also have been referred to as ‘entity parameters’). The application parameters 134 may include a Return on Investment (ROI) parameter and a futuristic criticality parameter. Therefore, upon the entity level analysis, a refined budget 136 may be calculated based on the application parameters 134.

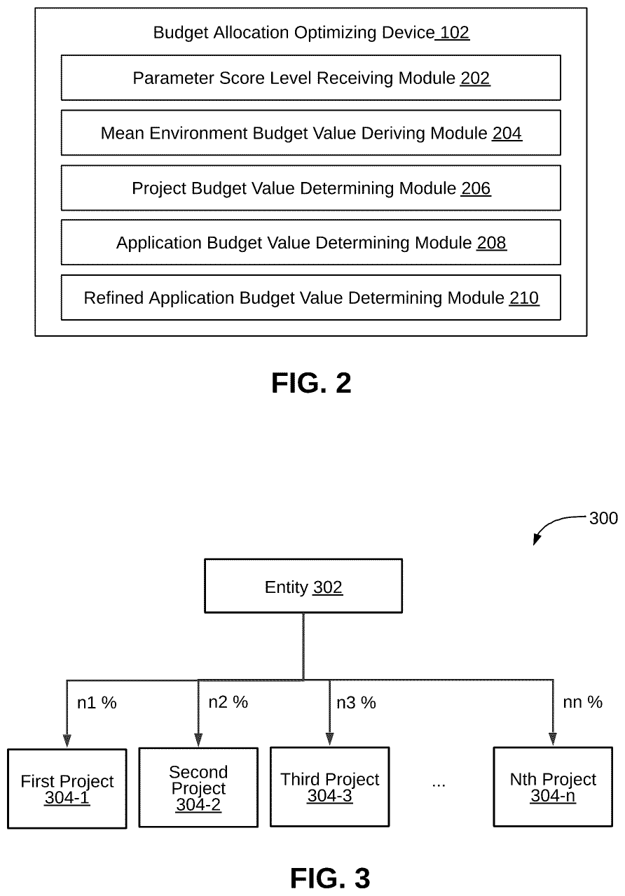

Referring now to FIG. 2, a block diagram of the budget allocation optimizing device 102 showing one or more modules is illustrated, in accordance with some embodiments. In some embodiments, the budget allocation optimizing device 102 may include a parameter score level receiving module 202, a mean environment budget value deriving module 204, a project budget value determining module 206, an application budget value determining module 208, and a refined application budget value determining module 210.

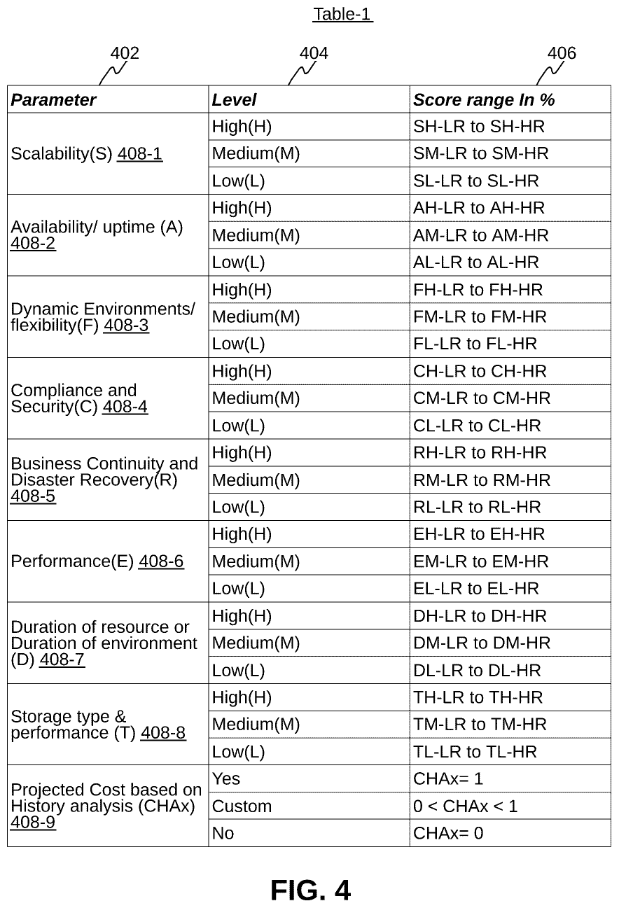

The parameter score level receiving module 202 may be configured to, for a project of one or more projects associated with the application and for an environment of one or more environments, receive a parameter score level corresponding to a parameter of a set of parameters, based on relevance of the parameter to the environment. The parameter score level may correspond to a range of parameter score values. It should be noted that the parameter score level may be received by way of selecting a parameter score level from a plurality of potential predefined parameter score levels. The parameter score level may be selected based on interviews, discussions, or sessions conducted with the sub-entity or users associated with the sub-entity. For example, a mapping may be created for the set of parameters with the possible parameter score levels and the corresponding range of parameter score values (as shown in FIG. 4). As such, based on the interviews, discussions, or sessions, the relevant score level for each parameter may be manually selected by the user conducting the interviews, discussions, or sessions with the sub-entity. Once the parameter score level is selected, the same may be received by the parameter score level receiving module 202.

Assuming an example scenario, an entity (e.g. a team head) has a fixed cloud budget wants to split the cloud budget effectively among a plurality of sub-entities (e.g. projects). The sub-entities may use different cloud providers with their respective cloud services, however, one a collective budget. The entity (i.e. the team head) may have a budget of “P” dollars for a time period “T”, with a budget allocation cycle time period being “t”. Therefore, for each budget cycle, the entity may have the budget for allocation as follows (in dollars):

$$Each cycle budget = t * \frac{P}{T} \qquad Equation ( 1 )$$

From the Equation (1), assuming p₁% is kept as reserve to defend against unpredictability and p₂% is kept as shared budget among different projects. Then, the budget for the entity for each budget cycle is as follows (in dollars):

$$Each cycle budget for allocation ( N ) = t * \frac{P}{T} - {p}_{1} \% of ( t * \frac{P}{T} ) - {p}_{2} \% of ( t * \frac{P}{T} ) \qquad Equation ( 2 )$$

It should be noted that, for the entity, it may not be the right approach to allocate the same amount to each project; an ideal allocation should aim for good business value. The entity may have different projects among which the “N” budget may be effectively split. An example entity and sub-entity relationship is illustrated in FIG. 3.

FIG. 3 illustrates a block diagram of an example entity and sub-entity relationship 300, in accordance with some embodiments. It should be noted that the entity may use the cloud for various purposes, such as website and application hosting, storage, data analytics services, R&D for new resource planning, etc. As shown in FIG. 3, a team head (i.e. entity) 302 may be assigned with “n” number of projects, namely a first project 304-1 (e.g. a R&D project), a second project 304-2, . . . . Nth project 304-n. Further, as shown, each of the above projects may be allocated a respective budget share, for example, the first project 304-1 may be allocated “n1” % of the “N” budget, the second first project 304-2 may be allocated “n2” % of the “N” budget, and so on.

As will be understood by those skilled in the art, in software development, multiple environments may collectively form a systematic and regulated progression from development through testing, demonstration, and production, i.e. starting with development and ending with production. The software development cycle includes one or more environments, as follows:

### (1) Development Environment (Dev):

An isolated development environment allows programmers to try new things and make changes repeatedly, thereby making them more flexible and quicker to adapt to changing needs. As a result, the programmers are able to quickly deliver software solutions without affecting the security of production.

### (2) Testing Environment:

The testing environment ensures that software is reliable and of high quality by testing units, integrations, and whole systems. Real-world event models of the testing environment help find and fix problems early on, which lowers the risk of sending low quality software to production.

### (3) Demo Environment:

The demo environment is an important part of the software development lifecycle because it gives stakeholders a unique place to test how well the software meets requirements. This encourages collaboration and makes sure that the end-result meets company goals.

### (4) Staging Environment:

The staging (intermediary) environment is the last and most important step in the software development process. The staging environment provides for conducting performance tests and validations, to lower the risk of putting broken or inefficient software into live production. As such, the staging environment ensures that the software works perfectly in real life.

### (5) Production Environment:

The production environment is the final phase in the software development cycle, that guarantees the delivery of dependable, adaptable, and high-performing software to end-users. The smooth functioning of the operation has a direct impact on customer satisfaction, which in turn enhances the organization's reputation and competitiveness in the business environment.

### (6) Research and Development (R&D) Environment:

In software development, the R&D environment provides for testing new ideas, and helps with making strategic choices and putting the company on the cutting edge of innovation so it can be ahead of market trends. It is very important for setting best practices and making sure that businesses are competitive and able to change.

The above environments may be governed by the set parameters. Each of the environments and parameters may be interconnected and inter-dependent. For example, the set of parameters may include a ‘scalability’ parameter, an ‘availability’ parameter, a ‘flexibility’ parameter, a ‘compliance and security’ parameter, a ‘business continuity and disaster recovery’ parameter, a ‘performance’ parameter, a ‘duration of resource’ parameter, and a ‘storage type and performance’ parameter. The set of parameters are explained in detail below.

### (1) Scalability Parameter

Cloud-based computing scalability may refer to the capacity of an organization to dynamically adjust its information technology (IT) resources in response to fluctuations in the demand. This scalability allows organizations to address spikes quickly, easily, and conveniently in traffic by simply scaling up or down on a dashboard with a few clicks. It should be noted that cloud cost and scalability of cloud computing are directly correlated. The need for scalable infrastructure varies depending on the projects and the environment.

### (2) Availability (Uptime) Parameter:

Eliminating single points of failure is referred to as high availability. As such, a system or a component having high availability is consistently operational for a longer period of time. This is crucial for mission-critical systems, as they are unable to withstand service disruptions; any downtime may lead to damage or financial loss. In addition, highly available environments necessitate substantial investments in the cloud to meet business demands.

### (3) Flexibility (Dynamic Environments) Parameter:

Cloud providers have the ability to allocate workloads across various services, including Infrastructure as a Service (IaaS), Platform as a Service (PaaS), and Software as a Service (SaaS). Each service offers a unique pricing model for cloud usage from which a user may choose one, based on their needs and available funds. In For example, in Google Cloud Platform (GCP), application deployment is available on Compute Engine, Google Kubernetes Engine (GKE), serverless cloud run service, and so on. Therefore, it may be possible to opt for lower pricing resource deployment, based on flexibility with environment.

### (4) Compliance and Security Parameter:

Data breaches, unauthorized access, and service outages are all potential security issues in cloud systems. Security procedures serve to limit these risks while also ensuring data confidentiality, integrity, and availability. Many businesses and countries have their own set of legal and regulatory requirements for data storage, processing, and transmission. Compliance with these criteria might be a legal necessity, and may contribute to the development of trust with customers and stakeholders. Cloud service providers may provide a variety of specialized security services, including advanced threat detection, identity and access management, and encryption. These services frequently have additional charges dependent on usage.

### (5) Business Continuity and Disaster Recovery:

Implementing Business Continuity (BC) and Disaster Recovery (DR) strategies in the cloud is essential for ensuring the resilience of IT systems. However, this may have implications on operational efficiency and costs. In the cloud, BC involves considerations such as redundancy, data backups, and load balancing, each influencing costs. DR strategies often include data replication, achieving lower recovery times, and regular testing, all of which may incur additional expenses.

### (6) Performance Parameter:

Performance in the cloud plays a pivotal role in determining both user experience and operational efficiency, and it directly influences cloud costs. Optimal performance involves selecting appropriate computing resources, storage solutions, and network configurations to meet the demands of applications and workloads. While utilizing high-performance resources enhances efficiency, it can also escalate costs. Cloud providers offer various instance types, each with different performance characteristics and costs. Balancing performance requirements with cost considerations is crucial—using overpowered resources may lead to unnecessary expenses, while undersized resources might result in degraded performance. Therefore, striking a balance between achieving desired performance levels and controlling costs is essential for maximizing the value of cloud investments.

### (7) Duration of Resource (Duration of Environment) Parameter:

The duration of resource utilization or the lifespan of an environment in the cloud may influence the overall cost structure. Cloud providers may charge based on the amount of time resources are provisioned and actively used. Longer durations of resource utilization, such as persistent virtual machine instances or continuously running services, can result in higher costs. On the other hand, short-lived or ephemeral resources, which are used for specific tasks and then terminated, may offer cost savings. Cloud cost models may include a combination of on-demand, reserved, and spot instances, each with its pricing structure based on utilization duration. Balancing the need for constant availability with the optimization of resource usage duration is the key to achieving cost-effective operations in the cloud.

### (8) Storage Type and Performance Parameter:

The choice of storage type and its performance characteristics in the cloud is a critical factor that directly influences both application efficiency and cost considerations. Cloud providers offer a variety of storage options, including standard, premium, and cold storage, each differing in terms of performance and cost. Standard storage is often more cost-effective for infrequently accessed data, while premium storage provides higher throughput and lower latency for performance-sensitive applications. Opting for higher-performing storage solutions may result in increased costs. Additionally, factors such as data redundancy and replication for ensuring data durability and availability may contribute to the overall cost of storage. Striking a balance between the performance needs of applications and the cost-effectiveness of storage solutions is, therefore, essential. Utilizing storage tiers effectively, implementing data lifecycle management strategies, and regularly reviewing storage requirements may help optimize costs while ensuring the necessary performance for cloud-based workloads.

### (9) History-Based Projected Cost Parameter:

Future expenditures may be predicted by analyzing historical budget data. Businesses can make budget estimates by studying past budgetary patterns, expenditure trends, and financial data. This forward-looking research may help identify budgetary peaks, expenditure spikes, and unexpected cost influencers. With this insight, organizations may make strategic budget allocation, scalability, and optimization decisions to meet financial goals.

It should be noted that the one or more environments and the one or more parameters may be interconnected, and as a result, inter-dependent.

A baseline project cost may be defined for each project (associated with the application). It should be noted that the application may involve multiple projects (e.g. project-1, project-2, R&D project, as will be discussed in the subsequent sections of this disclosure). The baseline project cost may be the cost associated with a running application under normal conditions. For example, a project (project-1) deployed on an ‘Azure’ Virtual Machine (VM) with 4 vCPUs, 8 GB of RAM, and 100 GB of storage running for a month may cost an estimated 1000 dollars. Similarly, the baseline project cost may be defined for all the projects. In particular, for project-1 (a1), project-2 (a2), and R&D project (rd), the respective baseline project cost (B) may be defined Ba1, Ba2, and Brd. In some embodiments, for the R&D environment, the baseline project cost may be the projected cost based on historical analysis.

As mentioned above, the parameter score level receiving module 202 may be configured to receive a parameter score level corresponding to a parameter of a set of parameters (for a project of one or more projects associated with the application and for an environment of one or more environments), such that the parameter score level corresponds to a range of parameter score values. It should be noted that, based on the level of impact that a parameter has on the environment, the budget value may either increase or decrease in relation to the baseline project cost, since the environments and parameters are interdependent. This is because, depending on the environment, some of the parameters may be more important than others, and therefore have a greater level of impact. For example, some environments may place a higher importance on the ‘performance’ parameter than others. Some contexts may permit a degree of flexibility in terms of resource requirements, whereas others may not.

In some example implementations, a range of parameter score values may be associated with each parameter that depends on the level impact the parameter has on the environment. The range of parameter score values may be positive or negative, depending on the parameter under consideration. For example, for a project that requires a production environment with improved ‘performance, the ‘performance’ parameter may have a higher level of impact, i.e. a positive range of parameter score values. If a project does not require the environment to be continuously run, then a parameter score level may be associated for the ‘duration of resource’ parameter, therefore implying a negative range of parameter score values—this may imply downgrading the budget.

Referring now to FIG. 4, a Table-1 for an exemplary environment representing various parameters in column 402, the respective possible parameter score levels in column 404, and corresponding range of parameter score values in column 406 is illustrated, in accordance with an exemplary embodiment. As shown in Table-1, for the ‘scalability’ parameter 408-1, the possible parameter score levels may include High (H), Medium (M), and Low (L). Further, for the ‘scalability’ parameter: for the High (H) parameter score level, the corresponding range of parameter score values may be represented as SH-LR to SH-HR (here, SH-LR represents ‘scalability’ parameter higher with lower range % value, and SH-HR represents ‘scalability’ parameter higher with higher range % value); for the Medium (M) parameter score level, the corresponding range of parameter score values may be represented as SM-LR to SM-HR (here, SM-LR represents ‘scalability’ parameter medium with lower range % value, and SM-HR represents ‘scalability’ parameter medium with higher range % value); and for the Low (L) parameter score level, the corresponding range of parameter score values may be represented as SL-LR to SL-HR (here, SL-LR represents ‘scalability’ parameter lower with lower range % value, and SL-HR represents ‘scalability’ parameter lower with higher range % value). Similarly, the possible parameter score levels and corresponding range of parameter score values are provided for the rest of the parameters, i.e. the ‘availability’ parameter 408-2, the ‘flexibility’ parameter 408-3, the ‘compliance and security’ parameter 408-4, the ‘business continuity and disaster recovery’ parameter 408-5, the ‘performance’ parameter 408-6, the ‘duration of resource’ parameter 408-7, and the ‘storage type and performance’ parameter 408-8. Additionally, for a ‘projected cost based on history analysis (CHAₓ)’ 408-9, the possible parameter score levels may include Yes, Custom, and No. Further, for the ‘projected cost based on history analysis (CHAₓ)’ 408-9: for the Yes parameter score level, the corresponding range of parameter score values may be represented as CHA=1, for the Custom parameter score level, the corresponding range of parameter score values may be represented as 0<CHAₓ<1; and for the No parameter score level, the corresponding range of parameter score values may be represented as CHA=0.

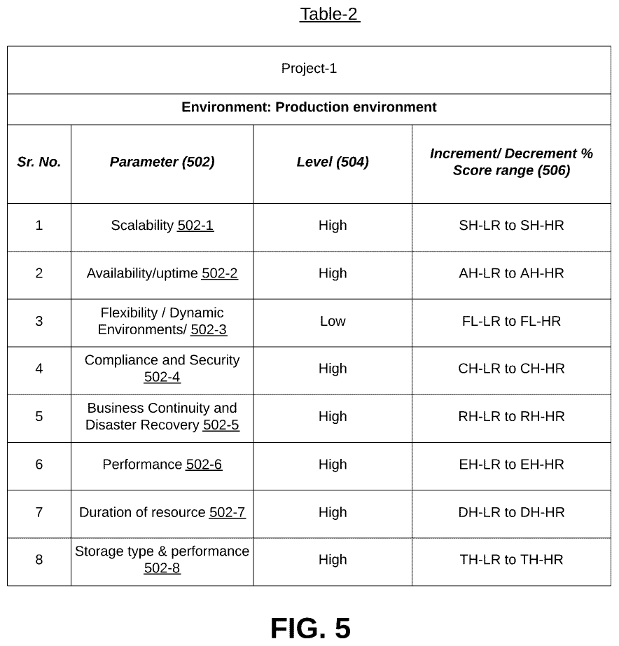

Referring now to FIG. 5, a Table-2 showing parameter score levels (in column 504) and corresponding range of parameter score values (in column 506) for a set of parameters (in column 502), for the ‘production’ environment is illustrated, in accordance with example embodiments. As shown in Table-2, for the said environment, for the ‘scalability’ parameter 502-1, a parameter score level of High may be received. Therefore, with reference to the Table-1, the corresponding range of parameter score values for the ‘scalability’ parameter 502-1 is SH-LR to SH-HR. Similarly, for the rest of the parameters 502-2 to 502-8, the parameter score levels received and the corresponding range of parameter score values are shown in rows 504 and 506, respectively.

Referring once again to FIG. 2, the mean environment budget value deriving module 204 may be configured to, for a project of one or more projects associated with the application, and for the environment, derive a mean environment budget value based on the range of parameter score values corresponding to each of the set of parameters. In particular, in order to derive the mean environment budget value, first a low range budget value and a high range budget value may be derived.

For example, the low range budget value (LRₐ₁ₚ) for the ‘production’ environment (p) for a project-1(a1) may be derived as follows:

$${LR}_{a 1 p} = {B}_{a 1} + ( SH - LR ) \% of {B}_{a 1} + ( AH - LR ) \% of {B}_{a 1} + ( FL - LR ) \% of {B}_{a 1} + ( CH - LR ) \% of {B}_{a 1} + ( RH - LR ) \% of {B}_{a 1} + ( EH - LR ) \% of {B}_{a 1} + ( DH - LR ) \% of {B}_{a 1} + ( TH - LR ) \% of {B}_{a 1} \qquad Equation ( 3 )$$

The high range budget value (HRₐ₁ₚ) for the ‘production’ environment (p) for the project-1(a1) may be derived as follows:

$${HR}_{a 1 p} = {B}_{a 1} + ( SH - HR ) \% of {B}_{a 1} + ( AH - HR ) \% of {B}_{a 1} + ( FL - HR ) \% of {B}_{a 1} + ( CH - HR ) \% of {B}_{a 1} + ( RH - HR ) \% of {B}_{a 1} + ( EH - HR ) \% of {B}_{a 1} + ( DH - HR ) \% of {B}_{a 1} + ( TH - HR ) \% of {B}_{a 1} \qquad Equation ( 4 )$$

The mean environment budget value deriving module 204 may derive the mean environment budget value (BMₐ₁ₚ) for the environment based on the low range budget value (LRₐ₁ₚ) and the high range budget value (HRₐ₁ₚ).

The project budget value determining module 206 may determine a project budget value based on a summation of: the mean environment budget value and an associated environment weightage corresponding to each of the one or more environments. The application budget value determining module 208 may determine an application budget value based on a summation of: project budget value and an associated project weightage corresponding to each of the one or more projects.

In some embodiments, in addition to the above set of parameters, a cost history analysis value may be taken into consideration for determining the application budget value. The cost history analysis value may be based on the history analysis of that environment. The cost history analysis value may be a cost based on analysis of historical budget data. For instance, the cost history analysis value may be based on analysis of past budgetary patterns, expenditure trends, and financial data, using which businesses (i.e. entities) to make budget estimates. As such, the budget allocation optimizing device 102 may have the flexibility to determine budgets based on the mean environment budget value (BMₐ₁ₚ) and customized with the history analysis of that environment. As shown in FIG. 4, for the cost history analysis value (CHAₓ) may be selected from a range of 0 and 1, i.e.

$$0 \leq {CHA}_{x} \leq 1$$

where,
CHAₓ=parameter for projected cost based on history analysis.

Therefore, the project budget value determining module 206 may determine a final project budget value (FBMₐ₁ₚ) based on the project budget value and the cost history analysis value (CHAₓ). Further, the application budget value determining module 208 may determine the application budget value based on a summation of: final project budget value and the associated project weightage corresponding to each of the one or more projects.

The final project budget value (FBMₐ₁ₚ) may be calculated as follows:

$${FBM}_{a 1 p} = {CHA}_{a 1 px} * {CHA}_{a 1 p} + ( 1 - {CHA}_{a 1 px} ) * {BM}_{a 1 p} \qquad Equation ( 5 )$$

here,
FBMₐ₁ₚ=final budget of Project-1(a1) for Production environment(p),
CHAₐ₁ₚₓ=parameter for projected cost based on history analysis for Project-1(a1) with production environment(p),
CHAₐ₁ₚ=projected cost based on history analysis of Project-1(a1) with production environment(p), and
BMₐ₁ₚ=mean environment budget value, i.e. budget before consideration of cost based on history analysis for Project-1(a1) with production environment (p).

The projected cost based on history analysis may be same as current budget use CHAₐ₁ₚₓ=1, i.e. FBMₐ₁ₚ=CHAₐ₁ₚ

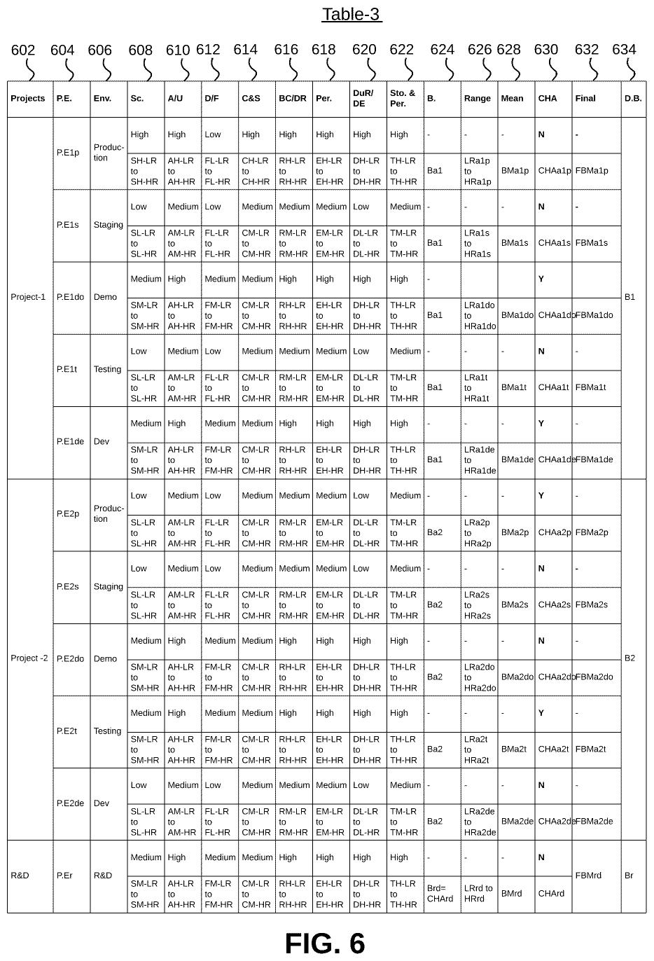

In the same way as above, the final project budget value for the rest of the projects may be determined. This is further explained in conjunction with FIG. 6.

Referring now to FIG. 6, Table-3 is illustrated that shows the process of deriving the application budget value. For example, as shown in FIG. 6, the various projects (i.e. project-1, project-2, R&D project) are tabulated in a column 602, the various environments are tabulated in column 606, a priority (P.Eₓ) associated with each of the environments is tabulated in a column 604, and the parameter score level received for the set of parameters are tabulated between columns 608 to 622. In particular, the parameter score level received for the ‘scalability’ (Sc) parameter is tabulated in the column 608, the parameter score level received for the ‘availability’ (A/U) parameter is tabulated in the column 610, the parameter score level received for the ‘flexibility’ (D/F) parameter is tabulated in the column 612, the parameter score level received for the ‘compliance and security’ (C&S) parameter is tabulated in the column 614, the parameter score level received for the ‘business continuity and disaster recovery’ (BC/DR) parameter is tabulated in the column 616, the parameter score level received for the ‘performance’ (Per.) parameter is tabulated in the column 618, the parameter score level received for the ‘duration of resource’ (DuR/DE) parameter is tabulated in the column 620, and the parameter score level received for the ‘storage type and performance’ (Sto. & per) parameter is tabulated in the column 622.

Further, the baseline project cost (B) is tabulated in column 624, a range between the low range budget value and the high range budget value (i.e. LRₐ₁ₚ to HRₐ₁ₚ, etc.) is tabulated in column 626, and the mean environment budget value (BMₐ₁ₚ) for the environment is tabulated in the column 628. Furthermore, the projected cost based on history analysis (CHA) is tabulated in the column 630. The final project budget value (i.e. FBMₐ₁ₚ, etc.) is tabulated in the column 632. A derived budget for the project is tabulated in column 634. Further, as can be seen, for each project, a parameter score level and the corresponding range of parameter score values for each parameter of the set of parameters is given. For example, for the project-1, for the production environment, the parameter score level and the corresponding range of parameter score values for the ‘scalability’ (Sc) parameter are ‘High’ and ‘SH-LR to SH-HR’, respectively. Similarly, for the project-1, for the production environment, the parameter score level and the corresponding range of parameter score values for the ‘availability’ (A/U) parameter are ‘High’ and ‘AH-LR to AH-HR’, respectively, and so on.

For a project of one or more projects associated with the application, a project budget value may be determined based on a summation of: the mean environment budget value and an associated environment weightage corresponding to each of the one or more environments. The associated environment weightage may correspond to the priority associated with the environment. As such, an environment with a higher priority may have a higher environment weightage. Further, in some embodiments, a final project budget value may be determined based on the project budget value and a cost history analysis value.

For example, with reference to Table-3, for the project-1, the project budget value may be derived based on a summation of: the final project budget value and an associated project weightage (P.E) corresponding to each of the one or more projects, as follows:

$${B}_{1} = {( P . E )}_{p} * {FBM}_{a 1 p} + {( P . E )}_{s} * {FBM}_{a 1 s} + {( P . E )}_{do} * {FBM}_{a 1 do} + {( P . E )}_{t} * {FBM}_{a 1 t} + {( P . E )}_{de} * {FBM}_{a 1 de} \qquad Equation ( 6 )$$

Similarly, for project-2, the project budget value may be derived as follows:

$${B}_{2} = {( P . E )}_{p} * {FBM}_{a 2 p} + {( P . E )}_{s} * {FBM}_{a 2 s} + {( P . E )}_{do} * {FBM}_{a 2 do} + {( P . E )}_{t} * {FBM}_{a 2 t} + {( P . E )}_{de} * {FBM}_{a 2 de} \qquad Equation ( 7 )$$

Further, for R&D environment, the project budget value may be derived as follows:

$${B}_{r} = {( P . E )}_{r} * {FBM}_{rd} \qquad Equation ( 8 )$$

The application budget value determining module 208 may determine the application budget value based on a summation of: project budget values corresponding to each of the one or more projects. Therefore, the application budget value (B) may be determined as follows:

$$( B ) = {B}_{1} + {B}_{2} + {B}_{r} \qquad Equation ( 9 )$$

### Entity Layer

In some embodiments, an additional entity layer may be deployed to derive refined budget value from the derived budget (D.B.) as calculated via process of Table-3. In this layer, entity parameter priority weightages may be applied to the project budget values. At the entity layer, one or more application parameters may be considered that may include a Return on Investment (ROI) entity parameter and a futuristic criticality parameter. The values corresponding to the application parameters may be collected after conducting interviews (or discussions or sessions) with entity owners or decision makers.

The refined application budget value determining module 210 may be configured to, for a project of one or more projects associated with the application, determine an updated project budget value based on the project budget value and an entity parameter priority weightage corresponding to each of the one or more application parameters. Further, the refined application budget value determining module 210 may be configured to determine an application budget value based on a summation of: updated project budget value corresponding to each of the one or more projects. To this end, the refined application budget value determining module 210 may receive a parameter score level corresponding to an entity parameter of a set of application parameters, based on relevance of the entity parameter to the environment, such that the entity parameter score level corresponds to entity parameter score values.

### (1) ROI/Spend Parameter:

Spending strategically and focusing on activities with a higher Return on Investment (ROI) may be important considerations when making business and investment decisions. A higher return on investment (ROI) may imply that the earnings or returns from an investment are greater than the costs. Therefore, allocating more resources and investing further in those activities may be preferred to capitalize on the favorable returns.

### (2) Futuristic Criticality Parameter

The entity may recognize the need of staying ahead of market changes, technology breakthroughs, and developing customer expectations by prioritizing investments according to their expected future worth. This approach may help in adopting strategic choices that may not yield immediate cash benefits but may position the organization for future success. The entity owner may have to decide the level of impact of both the application parameters and the weightage of the parameters, based on which respective score value may be obtained.

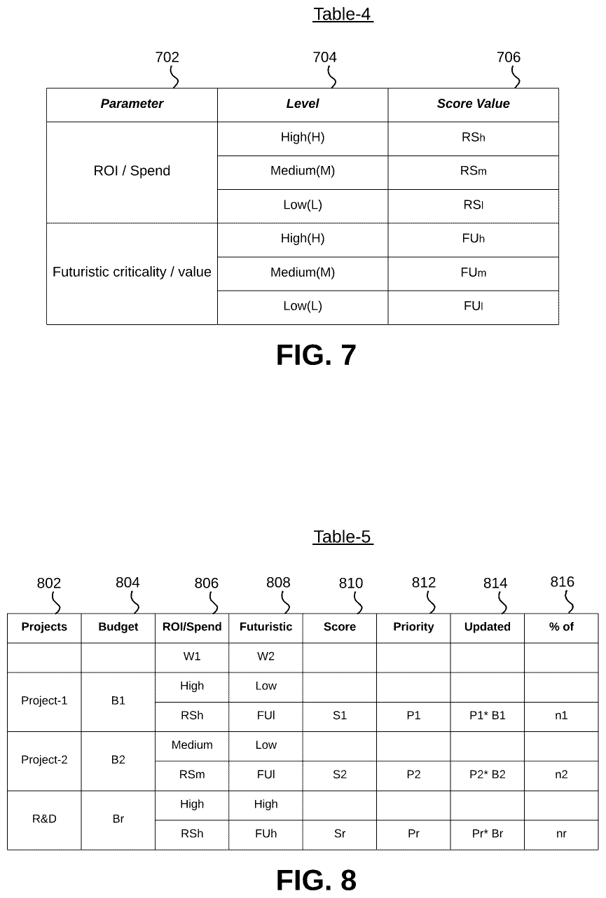

FIG. 7 illustrates Table-4 that shows the application parameters tabulated in column 702, entity parameter score levels tabulated in column 704, and corresponding entity parameter score values tabulated in column 706. For example, as shown in Table-4, for the ROI/Spend parameter, the possible entity parameter score levels may include High (H), Medium (M), and Low (L), and corresponding entity parameter score values may be RSₕ (representing score value of high level of ROI/Spend), RSₘ (representing score value of medium level of ROI/Spend), and RSₗ (representing score value of lower level of ROI/Spend). Similarly, for the futuristic criticality parameter, the possible entity parameter score levels may include High (H), Medium (M), and Low (L), and corresponding entity parameter score values may be FUₕ (representing score value of high level of futuristic criticality), FUₘ (representing score value of medium level of futuristic criticality), and FUₗ (representing score value of lower level of futuristic criticality).

FIG. 8 illustrates Table-8 that shows a process of determining refined budget for the application corresponding to the application parameters, in accordance with some embodiments. As can be seen, in the Table-5, the projects are tabulated in column 802, the project (baseline) budget value is tabulated in column 804, entity parameter score levels for the ROI/Spend parameter are tabulated in column 806, entity parameter score levels for the futuristic criticality parameter are tabulated in column 808, entity parameter score values are tabulated in column 810, priorities are tabulated in column 812, updated budget is tabulated in column 814, and percentage of allocation value is tabulated in column 816.

As shown in Table-5, for the project-1 with the project budget value B1, the entity parameter score level for the ROI/Spend parameter received may be High and therefore the entity parameter score value is RSₕ. Further, for the project-1, the entity parameter score level for the futuristic criticality parameter received may be Low and therefore the entity parameter score value is FUI. Further, it should be noted that a weightage W1 may be associated with the ROI/Spend parameter and a weightage W2 may be associated with the futuristic criticality parameter.

Assuming that the entity has a total budget N, and the derived budget for all the projects is B, the entity may give priority to certain projects. For example, project-1, project-2, and R&D project are given priorities of P1, P2, and Pr, respectively. Therefore, the total budget N may be represented as follows:

$${P}_{1} * {B}_{1} + {P}_{2} * {B}_{2} + {P}_{r} * {B}_{r} = N \qquad Equation ( 10 )$$

Further, the derived may be represented as below:

$${B}_{1} + {B}_{2} + {B}_{r} = B \qquad Equation ( 11 )$$

Referring to Table-5, the scores S₁ and S₂ may be calculated as below:

$${S}_{1} = {W}_{1} * {RS}_{h} + {W}_{2} * {FU}_{l} \qquad Equation ( 12 )$$

$${S}_{2} = {W}_{1} * {RS}_{m} + {W}_{2} * {FU}_{l} \qquad Equation ( 13 )$$

$${S}_{r} = {W}_{1} * {RS}_{h} + {W}_{2} * {FU}_{h} \qquad Equation ( 14 )$$

$$S = {S}_{1} + {S}_{2} + {S}_{r} \qquad Equation ( 15 )$$

$${S}_{1}^{′} = \frac{{S}_{1}}{S} , {S}_{2}^{′} = \frac{{S}_{2}}{S} , {S}_{r}^{′} = \frac{{S}_{r}}{S} \qquad Equation ( 16 )$$

here,
W1 and W2 are weightage for both the application parameters, respectively,
S1, S2, and Sr are score values based on the entity decision maker's level of impact of the parameters, and
S1′, S2′, and SY represent the ratio of the score of each corresponding project to the total score, which indicates the amount of weightage that is placed on the total.

Ratio of priorities may be represented as below:

$$\begin{matrix}\frac{{S}_{1}^{′}}{{S}_{2}^{′}} = \frac{{P}_{1}}{{P}_{2}} & \frac{{S}_{2}^{′}}{{S}_{r}^{′}} = \frac{{P}_{2}}{{P}_{3}} & \frac{{S}_{1}^{′}}{{S}_{r}^{′}} = \frac{{P}_{1}}{{P}_{3}}\end{matrix} \qquad Equation ( 17 )$$

Using the above Equations (10) and (17), P₁, P₂ & Pᵣ can be calculated. Further, based on the above priorities, the budget N may be revised, as follows:

$${n}_{1} = \frac{{P}_{1} * {B}_{1}}{N} * 100 \qquad Equation ( 18 )$$

$${n}_{2} = \frac{{P}_{2} * {B}_{2}}{N} * 100 \qquad Equation ( 19 )$$

$${n}_{r} = \frac{{P}_{r} * {B}_{r}}{N} * 100 \qquad Equation ( 20 )$$

here,
n₁, n₂, nᵣ are the percentage share of allocation of the budget.

The refined budgets may be calculated as:

$${B}_{1}^{′} = {P}_{1} * {B}_{1} \qquad Equation ( 21 )$$

$${B}_{2}^{′} = {P}_{2} * {B}_{2} \qquad Equation ( 22 )$$

$${B}_{r}^{′} = {P}_{r} * {B}_{r} \qquad Equation ( 23 )$$

here,
B1′, B2′, and Br′ are refined budgets for Project-1 (a1). Project-2 (a2), and the R&D Project, respectively.

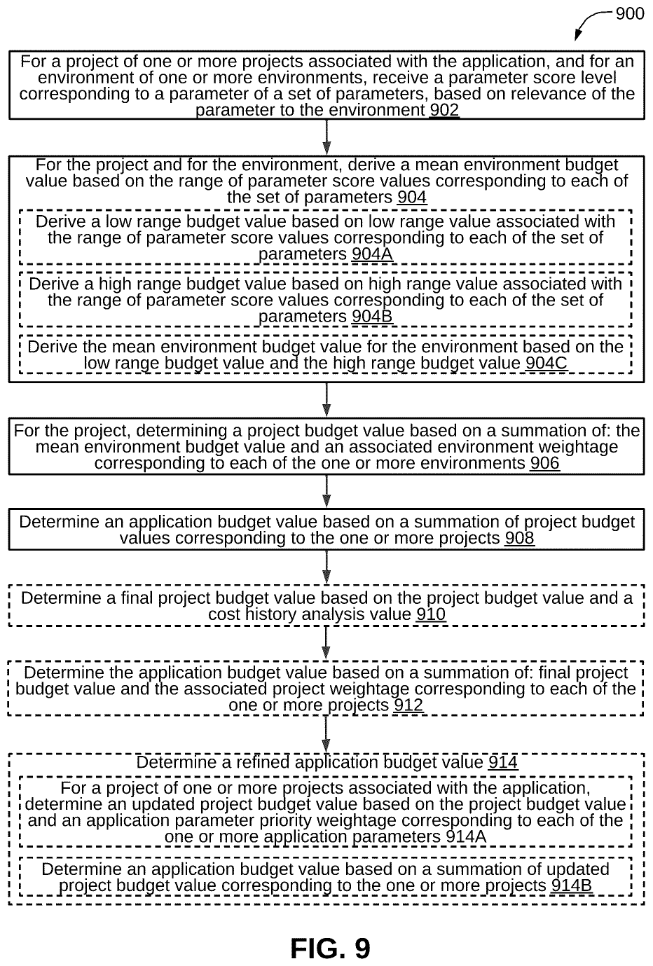

Referring now to FIG. 9, a flowchart of a method 900 of optimizing budget allocation for an application, in accordance with some embodiments of the present disclosure. The method 900, for example, may be performed by the budget allocation optimizing device 102.

At step 902, for a project of one or more projects associated with the application, and for an environment of one or more environments, a parameter score level corresponding to a parameter of a set of parameters may be received, based on relevance of the parameter to the environment. The parameter score level may correspond to a range of parameter score values. The parameter score level may be received by way of selecting a parameter score level from a plurality of potential predefined parameter score levels. As mentioned above, the parameter score level may be selected based on interviews, discussions, or sessions conducted with the sub-entity or users associated with the sub-entity. For example, a mapping may be created for the set of parameters with the possible parameter score levels and the corresponding range of parameter score values, as shown in FIG. 4. As such, based on the interviews, discussions, or sessions, the relevant score level for each parameter may be manually selected by the user conducting the interviews, discussions, or sessions with the sub-entity. Once the parameter score level is selected, the same may be received by the budget allocation optimizing device 102, at step 902.

At step 904, for the project and for the environment, a mean environment budget value may be derived based on the range of parameter score values corresponding to each of the set of parameters. In some embodiments, in order to derive the mean environment budget value, the method 900 may include steps 904A-904C. At step 904A, a low range budget value may be derived based on low range value associated with the range of parameter score values corresponding to each of the set of parameters. At step 904B, a high range budget value may be derived based on high range value associated with the range of parameter score values corresponding to each of the set of parameters. At step 904C, the mean environment budget value may be derived for the environment based on the low range budget value and the high range budget value.

At step 906, for the project, a project budget value may be determined based on a summation of: the mean environment budget value and an associated environment weightage corresponding to each of the one or more environments. The weightage corresponding to each of the one or more environments is already explained above in conjunction with FIG. 6 (Table-3). At step 908, an application budget value may be determined based on a summation of project budget values corresponding to the one or more projects.

Additionally, in some embodiments, at step 910, a final project budget value may be determined based on the project budget value and a cost history analysis value. At step 912, the application budget value may be determined based on a summation of: final project budget value and the associated project weightage corresponding to each of the one or more projects.

In some embodiments, at step 914, a refined application budget value may be determined. To this end, the method 900 may further include steps 914A-914B, at step 9014A, for a project of one or more projects associated with the application, an updated project budget value may be determined based on the project budget value and an entity parameter priority weightage corresponding to each of the one or more application parameters. At step 914B, an application budget value may be determined based on a summation of updated project budget value corresponding to the one or more projects.

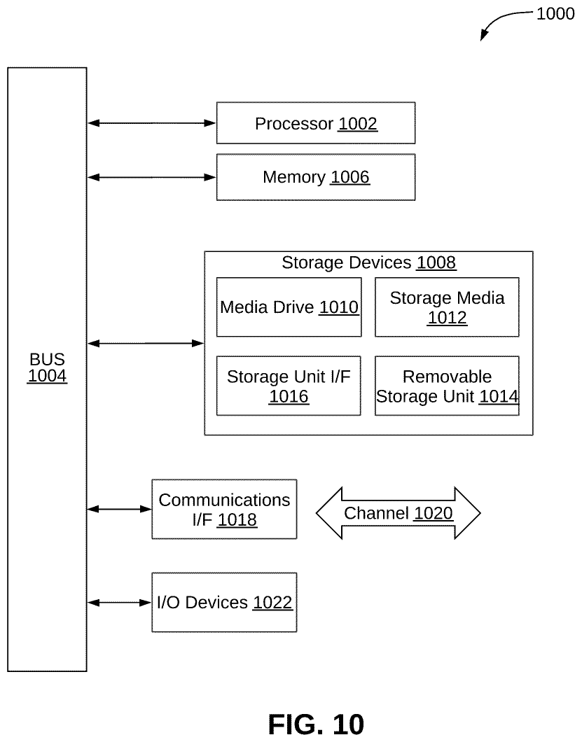

Referring now to FIG. 10, an exemplary computing system 1000 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1000 may represent, for example, a user device such as a desktop, a laptop, a mobile phone, personal entertainment device, DVR, and so on, or any other type of special or general-purpose computing device as may be desirable or appropriate for a given application or environment. The computing system 1000 may include one or more processors, such as a processor 1002 that may be implemented using a general or special purpose processing engine such as, for example, a microprocessor, microcontroller or other control logic. In this example, the processor 1002 is connected to a bus 1004 or other communication media. In some embodiments, the processor 1002 may be an Artificial Intelligence (AI) processor, which may be implemented as a Tensor Processing Unit (TPU), or a graphical processor unit, or a custom programmable solution Field-Programmable Gate Array (FPGA).

The computing system 1000 may also include a memory 1006 (main memory), for example, Random Access Memory (RAM) or other dynamic memory, for storing information and instructions to be executed by the processor 1002. The memory 1006 also may be used for storing temporary variables or other intermediate information during the execution of instructions to be executed by processor 1002. The computing system 1000 may likewise include a read-only memory (“ROM”) or other static storage device coupled to bus 1004 for storing static information and instructions for the processor 1002.

The computing system 1000 may also include storage devices 1008, which may include, for example, a media drive 1010 and a removable storage interface. The media drive 1010 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1012 may include, for example, a hard disk, magnetic tape, flash drive, or other fixed or removable media that is read by and written to by the media drive 1010. As these examples illustrate, the storage media 1012 may include a computer-readable storage medium having stored therein particular computer software or data.

In alternative embodiments, the storage devices 1008 may include other similar instrumentalities for allowing computer programs or other instructions or data to be loaded into the computing system 1000. Such instrumentalities may include, for example, a removable storage unit 1014 and a storage unit interface 1016, such as a program cartridge and cartridge interface, a removable memory (for example, a flash memory or other removable memory module) and memory slot, and other removable storage units and interfaces that allow software and data to be transferred from the removable storage unit 1014 to the computing system 1000.

The computing system 1000 may also include a communications interface 1018. The communications interface 1018 may be used to allow software and data to be transferred between the computing system 1000 and external devices. Examples of the communications interface 1018 may include a network interface (such as an Ethernet or other NIC card), a communications port (such as for example, a USB port, a micro-USB port), Near field Communication (NFC), etc. Software and data transferred via the communications interface 1018 are in the form of signals which may be electronic, electromagnetic, optical, or other signals capable of being received by the communications interface 1018. These signals are provided to the communications interface 1018 via a channel 1020. The channel 1020 may carry signals and may be implemented using a wireless medium, wire or cable, fiber optics, or other communications medium. Some examples of the channel 1020 may include a phone line, a cellular phone link, an RF link, a Bluetooth link, a network interface, a local or wide area network, and other communications channels.

The computing system 1000 may further include Input/Output (I/O) devices 1022. Examples may include, but are not limited to a display, keypad, microphone, audio speakers, vibrating motor, LED lights, etc. The I/O devices 1022 may receive input from a user and also display an output of the computation performed by the processor 1002. In this document, the terms “computer program product” and “computer-readable medium” may be used generally to refer to media such as, for example, the memory 1006, the storage devices 1008, the removable storage unit 1014, or signal(s) on the channel 1020. These and other forms of computer-readable media may be involved in providing one or more sequences of one or more instructions to the processor 1002 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into the computing system 1000 using, for example, the removable storage unit 1014, the media drive 1010 or the communications interface 1018. The control logic (in this example, software instructions or computer program code), when executed by the processor 1002, causes the processor 1002 to perform the functions of the invention as described herein.

One or more techniques for optimizing budget allocation for an application are disclosed. The one or more techniques provide for a robust and unique framework for organizing cloud budget allocation, addressing critical challenges faced by entities leveraging cloud technologies. The innovative framework offers a multi-layer, multi-dimensional, and multi-level approach to analyzing and allocating cloud budgets, ensuring comprehensive and efficient management of cloud resources.

The framework introduces an efficient and unique framework for cloud budget allocation, enhancing the accuracy of financial planning and operational strategies. This framework addresses the common issue of actual spending exceeding budgeted amounts, thereby supporting better decision-making. With a multi-layer, multi-dimensional, and multi-level approach, the techniques provide a thorough analysis of budget allocation, that helps in tracking the effective utilization of cloud resources across different projects, ensuring optimal resource allocation. Further, by integrating various factors such as environments, sub-entity parameters, and application parameters, the techniques support informed decision-making. In short, the techniques offer a comprehensive solution to the challenges of cloud budget allocation, ensuring efficient use of cloud investments and supporting sustainable business growth in the cloud computing landscape.

It is intended that the disclosure and examples be considered as exemplary only, with a true scope and spirit of disclosed embodiments being indicated by the following claims.

What is claimed is:

1. A method of optimizing budget allocation for an application, the method comprising:
for a project of one or more projects associated with the application,
for an environment of one or more environments, receiving a parameter score level corresponding to a parameter of a set of parameters, based on relevance of the parameter to the environment, wherein the parameter score level corresponds to a range of parameter score values;
for the environment, deriving a mean environment budget value based on the range of parameter score values corresponding to each of the set of parameters; and
determining a project budget value based on a summation of: the mean environment budget value and an associated environment weightage corresponding to each of the one or more environments;
determining an application budget value based on a summation of project budget values corresponding to the one or more projects.

2. The method as claimed in claim 1, wherein receiving the parameter score comprises:
selecting a parameter score from a plurality of potential predefined parameter scores.

3. The method as claimed in claim 1, wherein deriving the mean environment budget value for the environment comprises:
deriving a low range budget value based on low range value associated with the range of parameter score values corresponding to each of the set of parameters;
deriving a high range budget value based on high range value associated with the range of parameter score values corresponding to each of the set of parameters; and
deriving the mean environment budget value for the environment based on the low range budget value and the high range budget value.

4. The method as claimed in claim 1 further comprising:
determining a final project budget value based on the project budget value and a cost history analysis value; and
determining the application budget value based on a summation of: final project budget value and the associated project weightage corresponding to each of the one or more projects.

5. The method as claimed in claim 1, wherein the one or more environments comprise: a development environment, a testing environment, a demo environment, a staging environment, a production environment, and a research and development (R&D) environment.

6. The method as claimed in claim 1, wherein the set of parameters comprise: a scalability parameter, an availability parameter, a flexibility parameter, a compliance and security parameter, a business continuity and disaster recovery parameter, a performance parameter, a duration of resource parameter, and a storage type and performance parameter.

7. The method as claimed in claim 1 further comprising determining a refined application budget value, wherein determining the refined application budget value comprises:
for a project of one or more projects associated with the application, determining an updated project budget value based on the project budget value and an entity parameter priority weightage corresponding to each of the one or more application parameters; and
determining an application budget value based on a summation of updated project budget values corresponding to the one or more projects.

8. The method as claimed in claim 1, wherein the one or more application parameters comprise: Return on Investment (ROI) entity parameter and a futuristic criticality parameter.

9. A system for optimizing budget allocation for an application, the system comprising:
a processor; and
a memory communicatively coupled to the processor, wherein the memory stores a plurality of processor-executable instructions, which upon execution by the processor, cause the processor to:
for a project of one or more projects associated with the application,
for an environment of one or more environments, receive a parameter score level corresponding to a parameter of a set of parameters, based on relevance of the parameter to the environment, wherein the parameter score level corresponds to a range of parameter score values;
for the environment, derive a mean environment budget value based on the range of parameter score values corresponding to each of the set of parameters; and
determine a project budget value based on a summation of: the mean environment budget value and an associated environment weightage corresponding to each of the one or more environments;
determine an application budget value based on a summation of project budget values corresponding to the one or more projects.

10. The system as claimed in claim 9, wherein deriving the mean environment budget value for the environment comprises:
deriving a low range budget value based on low range value associated with the range of parameter score values corresponding to each of the set of parameters;
deriving a high range budget value based on high range value associated with the range of parameter score values corresponding to each of the set of parameters; and
deriving the mean environment budget value for the environment based on the low range budget value and the high range budget value.

11. The system as claimed in claim 9, wherein the plurality of processor-executable instructions further cause the processor to:
determine a final project budget value based on the project budget value and a cost history analysis value; and
determine the application budget value based on a summation of: final project budget value and the associated project weightage corresponding to each of the one or more projects.

12. The system as claimed in claim 9, wherein the plurality of processor-executable instructions further cause the processor to:
determine a refined application budget value, wherein determining the refined application budget value comprises:
for a project of one or more projects associated with the application, determining an updated project budget value based on the project budget value and an entity parameter priority weightage corresponding to each of the one or more application parameters; and
determining an application budget value based on a summation of updated project budget values corresponding to the one or more projects.
